(19) United States
(12) Patent Application Publication
(10) Pub. No.: US 2008/0109568 A1
(43) Pub. Date: May 8, 2008

(54) Method and System for Detecting Device Configuration Changes

(76) Inventors: Varadachari Rengarajan, Cupertino, CA (US); Janakiraman Gopalan, Cupertino, CA (US)

Correspondence Address: FAY KAPLUN & MARCIN, LLP, 150 BROADWAY, SUITE 702, NEW YORK, NY, 10038, US

(21) Appl. No.: 11/556,456

(22) Filed: Nov. 3, 2006

(51) Int. Cl. G06F 3/00

(52) U.S. Cl. 710/19

(57) ABSTRACT

A system and method for storing a first configuration data file, altering the first configuration data file to create a second configuration data file and creating a reference value corresponding to the second configuration data file. In addition, a system and method for receiving a first reference value from a computing device, the first reference value corresponding to a first configuration data file utilized by the computing device, comparing the first reference value to a second reference value corresponding to a second configuration data file and upon detecting a difference between the first and second reference values, obtaining the first configuration data file from the computing device.

### FIELD OF THE INVENTION

The present invention relates generally to methods and systems for detecting a device configuration. In particular changes to device configurations.

### BACKGROUND

When a company is building a computing network, hundreds, if not thousands, of network infrastructure devices are deployed to interconnect network resources (e.g., databases, servers, etc.) and client devices (e.g., barcode scanners). For example, a retail chain may deploy switches, bridges, routers, access points/ports, etc. in each of its stores, allowing employees and/or customers using the barcode scanners to access data stored on servers in the store and/or remote servers at other locations in the network. Due to a size of the network, monitoring operation of each of the devices may require a significant portion of network bandwidth. For example, the company may want to be notified, e.g., for security purposes, about changes in device configurations. However, reporting every change in the device configurations for each device in the network would require a large amount of the network bandwidth.

### SUMMARY OF THE INVENTION

A method for storing a first configuration data file, altering the first configuration data file to create a second configuration data file and creating a reference value corresponding to the second configuration data file.

In addition, a method for receiving a first reference value from a computing device, the first reference value corresponding to a first configuration data file utilized by the computing device, comparing the first reference value to a second reference value corresponding to a second configuration data file and upon detecting a difference between the first and second reference values, obtaining the first configuration data file from the computing device.

A device having a memory storing a first configuration data file and a processor altering the first configuration data file to create a second configuration data file and creating a reference value corresponding to the second configuration data file.

A device having a memory storing a first reference value corresponding to a first configuration data file and a processor receiving a second reference value from a computing device, the second reference value corresponding to a second configuration data file utilized by the computing device, the processor comparing the first reference value to the second reference value and, upon detecting a difference between the first and second reference values, generating a request for the second configuration data file from the computing device.

A system having a first device having a first configuration file, the first device computing a first value based on the first configuration file and a second device having a reference configuration file and a reference value based on the reference configurations file, the second device receiving the first value from the first device and comparing the values, wherein, if the values are different, the second device requests the first configuration file from the first device.

### DESCRIPTION OF THE DRAWINGS

FIG. 1 shows an exemplary embodiment of a system for detecting a device configuration according to present invention.

FIG. 2 shows an exemplary embodiment of a method for reporting a change to a Saved Configuration according to the present invention.

FIG. 3 shows an exemplary embodiment of a method for reporting a change to a Running Configuration according to the present invention.

FIG. 4 shows a first exemplary embodiment of a method for detecting a change to a Saved Configuration according to the present invention.

FIG. 5 shows a second exemplary embodiment of a method for detecting a change to a Saved Configuration according to the present invention.

FIG. 6 shows an exemplary embodiment of a method for detecting a change to a Running Configuration according to the present invention.

### DETAILED DESCRIPTION

The present invention may be further understood with reference to the following description and the appended drawings, wherein like elements are referred to with the same reference numerals. The exemplary embodiments of the present invention describe a method and system for detecting a device configuration. In particular, the detection of changes to the device configurations. While the exemplary embodiments of the present invention will be described with reference to detecting a configuration of a wireless switch, those skilled in the art will understand that the methods and systems of the present invention may be utilized to monitor any performance aspect/setting (e.g., security, configuration, operability, malfunction, etc.) on any wired/wireless computing device in a communications network.

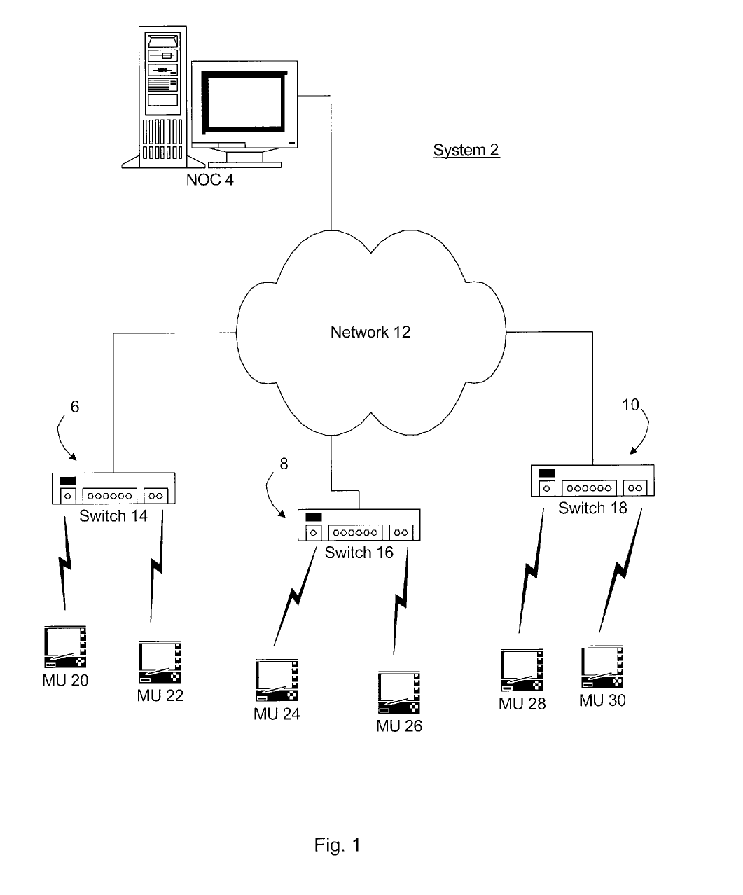

FIG. 1 shows an exemplary embodiment of a system 2 for detecting a device configuration according to the present invention. The system 2 may be implemented as, for example, a computing network for a retail store chain. A central server (e.g., a network operation center (NOC) 4) may be used to monitor subnetworks 6-10 deployed in each store in the chain via a communications network 12 (e.g., the Internet, a VPN, a WAN, etc.). As understood by those skilled in the art, the network 12 may include various wired/wireless network infrastructure devices including, but not limited to, servers, databases, switches, routers, bridges, repeaters, etc. In the exemplary embodiment, the subnetworks 6-10 may include one or more wireless switches 14-18 and/or access points/ports (not shown) that provide access to the network 12 for mobile computing units (MUs) 20-30. The MUs 20-30 may include, for example, imager-/laser-based scanners, RFID readers, mobile phones, laptops, PDAs, tablet computers, digital cameras, portable gaming devices, media players, etc. Those skilled in the art will understand that the subnetworks 6-10 may further include servers, databases, PCs, smart devices (e.g., copiers, fax machines, printers, etc.) which access the network 12 directly or via the switches 14-18 or other network computing devices.

According to the exemplary embodiments of the present invention, the NOC 4 monitors changes in configurations of computing devices in the network 12 and/or the subnetworks 6-10. The configurations may include, but are not limited to, communication and/or security protocols, keys, passwords, bandwidth usage, number/type of devices communicating with the computing device, user interface settings, etc. The computing devices may signal the configuration changes to the NOC 4, and/or the NOC 4 may poll the computing devices to determine whether any of the changes have occurred. While the exemplary embodiment will be described with reference to detecting the changes on the switch 14, those skilled in the art will understand that the changes may be detected on and/or reported by any computing device in the system 2 utilizing similar methods. Additionally, the methods may be implemented at any level in the system 2. For example, the switch 14 may monitor the changes for all devices (e.g., the MUs 20, 22) in the subnetwork 6, and then report the changes to the NOC 4 and/or wait until the NOC 4 requests the changes

The switch 14 may utilize two configurations: a Running Configuration and a Saved Configuration. The Running Configuration represents an operational configuration utilized as the switch 14 is currently operating. The Saved Configuration represents a default configuration that the switch 14 would utilize if it were restarted. Any changes made to the switch 14 while working are immediately reflected in the Running Configuration. As understood by those skilled in the art, the changes may be made via a command line interface (CLI), a simple network management protocol (SNMP) instruction, a remote monitoring (RMON) action, an applet, etc. for interfacing with the switch 14. If the Running Configuration is saved, it becomes (replaces) the Saved Configuration. Thus, it is possible that the Running and Saved Configurations may be identical (e.g., immediately after the switch 14 is reset/restarted). However, if the Running Configuration is not saved and the switch 14 is restarted, the Saved Configuration will be loaded and the change(s) made to the Running Configuration will be lost.

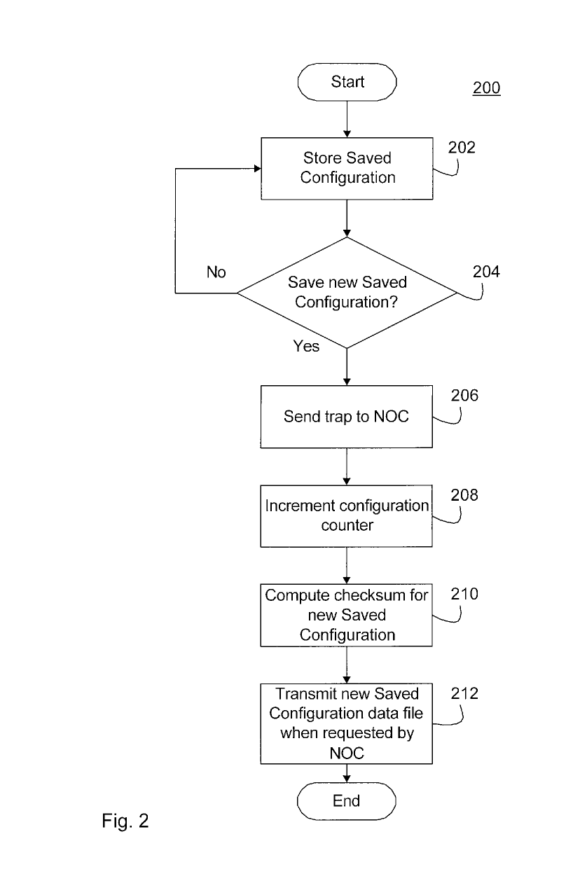

FIG. 2 shows an exemplary embodiment of a method 200 for detecting a device configuration according to the present invention. In particular, the method 200 is directed to determining a change in the Saved Configuration utilized by the switch 14. In step 202, the switch 14 has stored the Saved Configuration. When the switch 14 is first deployed, the Saved Configuration may represent a pre-programmed configuration generated by a manufacturer of the switch 14 or an IT professional deploying the switch 14 in the subnetwork 6. During operation, the Saved Configuration may be updated when the Running Configuration is saved, thereby replacing the Saved Configuration. In an exemplary embodiment, previous Saved Configurations may be archived at the switch 14, a database, the NOC 4, etc. to be reloaded to the switch 14 and/or analyzed (e.g., to identify the changes) at a later time.

In step 204, the switch 14 determines whether it has received a save command to save a new Saved Configuration (and replace the Saved Configuration). A command to save the new Saved Configuration may be received from a CLI, SNMP instruction, RMON action, applet, etc. which is used to interface with the switch 14. The save command may be issued from, for example, the NOC 4, a local computer coupled to the switch 14, a remote computer communicating with the switch 14 via the network 12, etc. If the command is not received, the switch 14 may simply maintain the Saved Configuration as currently saved and the method 200 waits for a save command to be received.

In step 206, the switch 14 generates an indicator signal (e.g., a trap) and transmits the trap to the NOC 4 (and/or any other device monitoring operation of the switch 14). The trap indicates that the switch 14 has received a save command, presumably to change the Saved Configuration on the switch 14 to a new Saved Configuration. This is described as presumably because it is possible that the switch 14 may receive a save command through, for example, a CLI interface, but the configuration settings have not actually been changed from the current Saved Configuration.

In step 208, a configuration counter is incremented. For example, the switch 14 may utilize a read-only management information base (MIB) variable that is indicative of a number of times that changes to the Saved Configuration have been saved. Additionally, the configuration counter may store data associated with saving the new Saved Configuration such as, for example, a date/timestamp. On initial start-up of the switch 14 or on a restart of the switch 14, the configuration counter may be reset to 0. Thus, the counter will maintain the number of times that a configuration has been saved between restarts of the switch 14.

In step 210, the switch 14 generates a representative value for the new Saved Configuration. In the exemplary embodiment, the switch 14 computes a checksum for the new Saved Configuration and may return the checksum through a MIB variable. Alternatively, the switch 14 may generate a hash or any other data structure that summarizes contents of the new Saved Configuration. The checksum will then be transmitted to the network device that is monitoring the switch configuration (e.g., the NOC 4). The checksum may be transmitted on the initiative of the switch 14 when the new Saved Configuration is saved or it may be initiated from the NOC 4 that requests the checksum when it receives the trap from the switch 14. However, in any case the checksum is sent to the NOC 4 (or other network configuration monitor).

As will be described in greater detail below, when the NOC 4 receives the checksum, the NOC 4 will compare the checksum to a previously stored or calculated checksum based on the Saved Configuration that the NOC 4 has for the switch 14. If the newly received checksum is different from the previously stored or calculated checksum, the NOC 4 will understand that the Saved Configuration at the switch 14 is different from the Saved Configuration that the NOC 4 has for the switch 14. Thus, the NOC 4 will request that the switch 14 send the new Saved Configuration. However, if the checksum matches the saved checksum, then the NOC 4 will not need the new Saved Configuration because it matches the current Saved Configuration that the NOC 4 has for the switch 14. Thus, even though the switch 14 may have received a save command, bandwidth of the network would not need to be used to send the new Saved Configuration file because the NOC 4 has the current Saved Configuration for the switch 14.

In step 212, a data file corresponding to the new Saved Configuration is transmitted to the NOC 4. As described above, this transmission will only take place if the checksum previously transmitted indicates that the new Saved Configuration is different from the Saved Configuration on record for the switch 14. In another exemplary embodiment, the data file may be stored at the switch 14 (or any other storage device on the subnetwork 6 or the network 12—e.g., an FTP server) for retrieval by the NOC 4 at a predetermined time. Thus, the NOC 4 may analyze the variables in the MIB on the switch 14 to determine whether the Saved Configuration has been changed and the new Saved Configuration should be obtained.

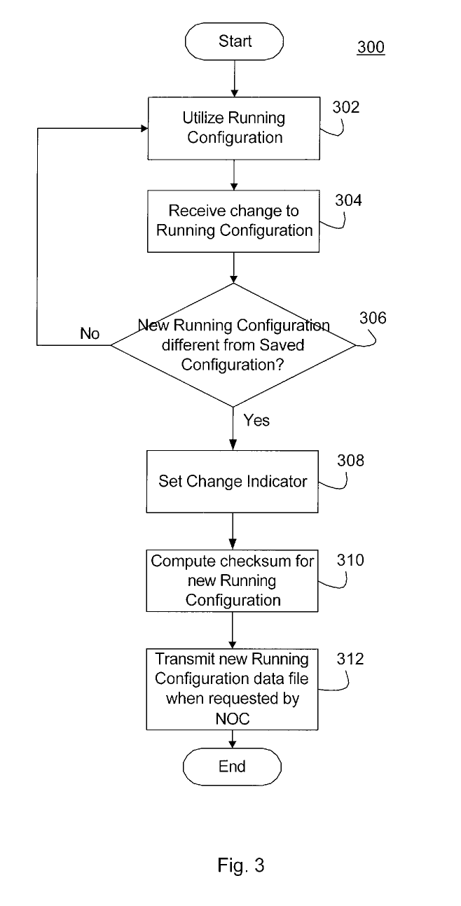

FIG. 3 shows an exemplary embodiment of a method 300 for detecting a device configuration according to the present invention. In particular, the method 300 is directed to determining a change in the Running Configuration utilized by the switch 14. In step 302, the switch 14 is utilizing the Running Configuration. As stated above, the Running Configuration is the configuration utilized by the switch 14 when it is powered and running. Thus, immediately after the switch 14 has been powered up and loaded the Saved Configuration, the Running Configuration will be the same as the Saved Configuration until the Running Configuration is changed.

In step 304, a change is made to the Running Configuration to generate a new Running Configuration. The change may be entered via the interface with the switch 14 (e.g., CLI, SNMP instruction, applet, etc.). Once the change is made, the switch 14 utilizes the new Running Configuration. In the exemplary embodiment, a trap is not generated for the change to the Running Configuration. This may prevent a flood of traps from spilling into the NOC 4 when there are more changes to be made. For example, several changes may be made to the Running Configuration, and generating a trap for each change may usurp network bandwidth by sending the Running Configuration each time a change is made.

In step 306, the switch 14 determines whether the new Running Configuration is different from the Saved Configuration (whether it is an original Saved Configuration or the new Saved Configuration). Any difference may be detected by comparing the respective data files and/or checksums thereof. In step 308, the switch 14 sets a change indicator (e.g., a flag value) to indicate whether the change to the Running Configuration has been made. The flag value may be implemented as a read-only boolean MIB variable. Initially, or after a restart, the flag may be set to false awaiting for the Running Configuration to be altered from the Saved Configuration. Thus, after a change is made to the Running Configuration so that it is different from the Saved Configuration, the flag may be set to true. As will be described in greater detail below, the network device that monitors the configurations (e.g., the NOC 4) may poll the flag to determine whether the Running Configuration has been changed from the Saved Configuration. By polling the flag, rather than pulling the entire file, the NOC 4 may determine whether a change has been made to the Running Configuration. In addition, it should be noted that when the switch 14 receives a save command, i.e., the Running Configuration is saved to the Saved Configurations, the flag is reset to false because the Running Configuration and the Saved Configuration will again be the same.

In step 310, the switch 14 generates a representative value for the new Running Configuration. In the exemplary embodiment, the switch 14 computes a checksum of the new Running Configuration and returns the checksum through a MIB variable. Alternatively, the switch 14 may generate a hash or any other data structure that summarizes contents of the new Running Configuration. The checksum for the Running Configuration is used in the same manner as the checksum for the Saved Configuration. That is, if the NOC 4 determines that the flag is set to true (the Running Configuration is different from the Saved Configuration), the checksum will be transmitted to the NOC 4 (either on the initiative of the switch 14 or based on polling by the NOC 4). The NOC 4 may then compare the checksum received from the switch 14 for the Running Configuration with the checksum stored at the NOC 4 for the Running Configuration or the desired configuration (described in greater detail below).

If these checksums are different, the NOC 4 may then request that the new Running Configuration of the switch 14 be transmitted to the NOC 4. Step 312 shows a data file corresponding to the new Running Configuration is transmitted to the NOC 4. In another exemplary embodiment, the data file may be stored at the switch 14 (or any other storage device on the subnetwork 6 or the network 12 e.g., an FTP server) for retrieval by the NOC 4 at a predetermined time. Thus, the NOC 4 may analyze the variables in the MIB on the switch 14 to determine whether the Running Configuration has been changed and the new Running Configuration should be obtained. However, as seen from the above, the transmission of step 312 will only occur upon certain conditions (e.g., the change flag is set to true and the current checksum is different from the stored checksum), thereby saving bandwidth by not transmitting unnecessary data to the NOC 4.

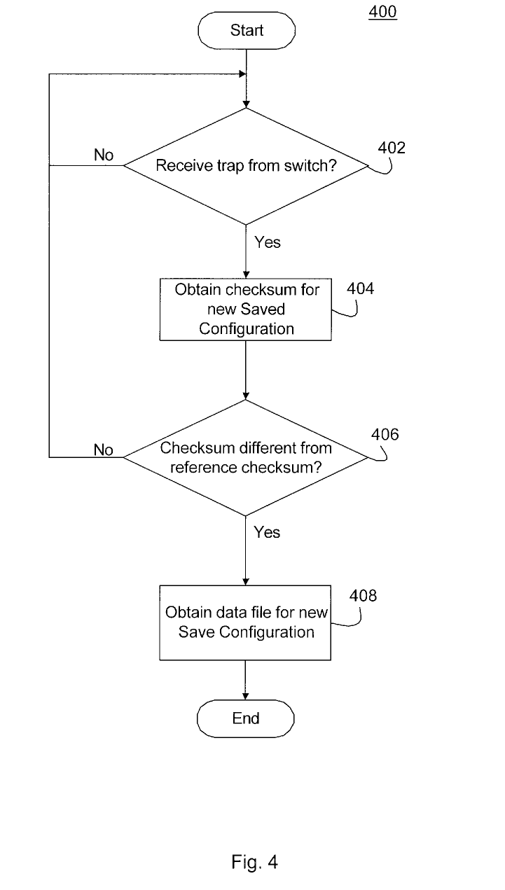

FIG. 4 shows an exemplary embodiment of a method 400 for detecting a device configuration. In particular, the method 400 is directed at determining when the Saved Configuration on the switch 14 has been changed. In the exemplary embodiment, the method 400 is executed on the NOC 4 or any other device communicatively coupled to the switch 14 and monitoring changes to the configuration thereof. For example, the NOC 4 may be utilizing a Mobility Services Platform (MSP) software package for tracking operation of the computing devices in the system 2. The MSP software may interface with and obtain information stored in the MIBs stored on the computing devices.

In step 402, the NOC 4 monitors incoming transmissions to determine if it has received an asynchronous trap from the switch 14. As described above, the switch 14 may generate a trap when it receives a save command for the configuration data. If no trap is received, the NOC 4 continues to monitor for a trap. When the NOC 4 receives the trap from the switch 14, the method continues to step 404, where the NOC 4 obtains the checksum for the new Saved Configuration. As stated above, the checksum may be represented as a variable in the MIB on the switch 14. Thus, the retrieval of the checksum from the MIB may be accomplished through a MIB request from the NOC 4 to the switch 14. In an alternative embodiment, the switch 14 may send the checksum as part of the trap communication.

In step 406, the NOC 4 determines whether the checksum for the new Saved Configuration is different from a reference checksum. The reference checksum may be a checksum for a Reference Configuration that may be a preferred configuration determined by a user/operator to be the most optimal configuration for the switch 14 or it may be the most recently obtained Saved Configuration. If the Reference Configuration checksum is identical to the Saved Configuration checksum received from the switch 14, the NOC 4 will determine that the Reference Configuration and the Saved Configuration are the same and therefore no additional steps need to be taken. Thus, the method 400 will loop back to step 402 to await a further trap. By transmitting only the checksums and not the entirely new Saved Configuration when there is no need, the exemplary embodiments save bandwidth within the network.

However, if the checksums are different, the method will continue to step 408, where the NOC 4 obtains the data file for the new Saved Configuration from the switch. By analyzing the data file, the change to the Saved Configuration file may be identified. An operator may then determine whether the change should be accepted or rejected. If the change is accepted, the data file for the new Saved Configuration and the checksum thereof may replace the Reference Configuration and the reference checksum. If the change is rejected, an instruction may be transmitted to the switch 14 to revert to the previous Saved Configuration and/or to use the Reference Configuration. Additionally, the data files for the new Saved Configuration and/or the Reference Configuration may be downloaded to one or more of the computing devices in the system 2 for replacing their respective Saved Configurations.

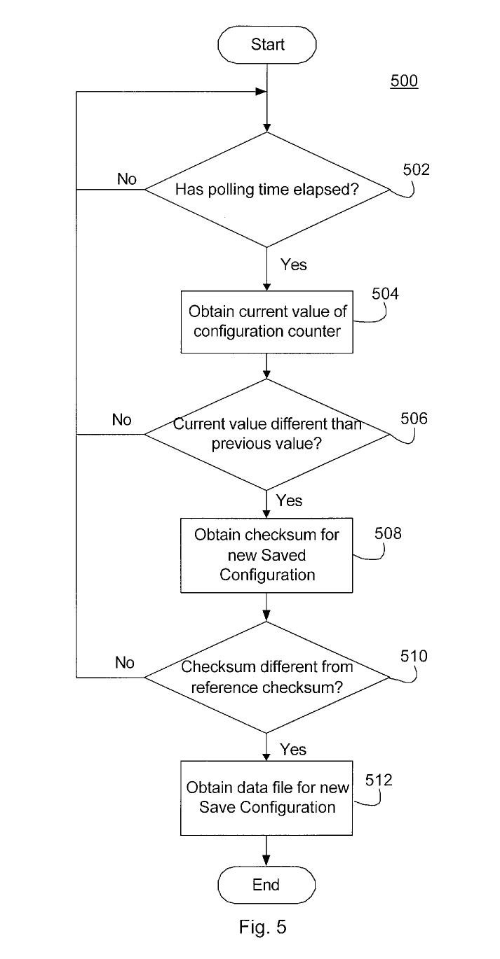

FIG. 5 shows an exemplary embodiment of a method 500 for detecting a device configuration. In particular, the method 500 is directed at determining when the Saved Configuration on the switch 14 has been changed. Similar to the method 400, the method 500 is executed on the NOC 4 or any other device communicatively coupled to the switch 14 and monitoring changes to the configuration thereof. In contrast to the method 400, the method 500 is executed by the NOC 4 as a polling process for detecting a change to the Saved Configuration. The polling process may be executed on a predetermined schedule (e.g., daily), after the switch 14 is restarted and/or reset, at predetermined time intervals (e.g., approximately every fifteen minutes), etc. Thus, the NOC 4 may detect changes to the Saved Configuration of the switch 14 without receiving a trap from the switch 14.

In step 502, it is determined whether the polling time has elapsed, e.g., if the polling time is set at fifteen minutes, has 15 minutes elapsed since the last polling of the switch. As described above, the polling time may be set at any time that is desired by the operator of the system 2. Different devices on the system may have different polling times. If the polling time has not elapsed, the method 500 will continue to loop until the polling time has elapsed.

After the polling time has elapsed, the method continues to step 504 where the NOC 4 obtains a current value from the configuration counter on the switch 14. As described above, the switch 14 will have a counter that increments each time that the switch receives a save command for the configuration settings. The NOC 4 will retrieve the current value, e.g., through a MIB request. In step 506, the NOC 4 compares the current value to a previous value stored thereby. If the current value of the configuration counter is unchanged since the last polling of the switch 14, the NOC 4 will know that there have been no subsequent changes to the Saved Configuration since the last poll. Thus, the method 500 will be complete and will loop back to step 502 to await the next polling period.

However, if the counter value has changed, the NOC 4 will understand that the switch 14 has received a saved command for the configuration settings since the last polling period. The method will then continue to steps 508 (obtain checksum from switch 14), 510 (compare checksums) and 512 (obtain new Saved Configuration) as needed. These steps 508-512 are not described in detail because they are identical to steps 404-408 described with reference to method 400.

Those skilled in the art will understand that the NOC 4 may simultaneously execute the methods 400 and 500 in order to effectively monitor the Saved Configurations for the devices in the system 2. That is, even if a trap does not reach the NOC 4 when a save command is received by the device, the subsequent polling of the device will pick up the potential change to the Saved Configuration. However, as can also be seen from the exemplary methods, the transmission of the full Saved Configuration file only occurs when the NOC 4 is satisfied that there has been an actual change to the Saved Configuration and that change should be implemented on the device.

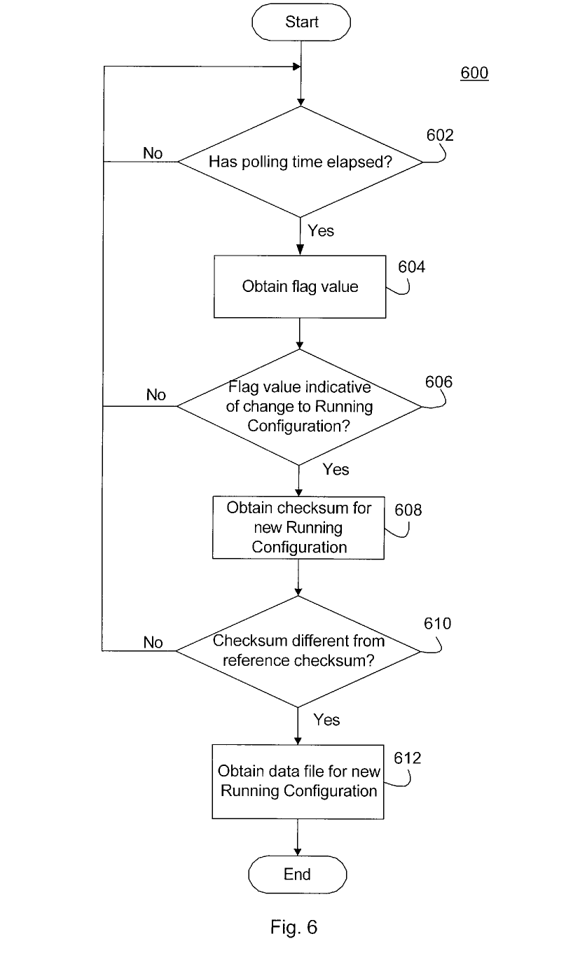

FIG. 6 shows an exemplary embodiment of a method 600 for detecting a device configuration. In particular, the method 600 is directed at determining when the Running Configuration on the switch 14 has been changed. The method 600 may be utilized during the polling process executed by the NOC 4 for detecting a change to the Running Configuration. The method 600 is similar to the method 500 in that it is a polling process for the Running Configuration.

In step 602, it is determined whether the polling time has elapsed, e.g., if the polling time is set at fifteen minutes, has 15 minutes elapsed since the last polling of the switch. As described above, the polling time may be set at any time that is desired by the operator of the system 2. Different devices on the system 2 may have different polling times. If the polling time has not elapsed, the method 600 will continue to loop until the polling time has elapsed.

After the polling period has elapsed, the method 600 continues to step 604 where the NOC 4 obtains the flag value on the switch 14. As stated above, the NOC 4 may transmit a MIB request for the variable stored as the flag value in the MIB at the switch 14. In step 606, the NOC 4 determines whether the flag value indicates that the Running Configuration has been changed and not yet saved. If the flag value indicates that the Running Configuration has not been changed, the method 600 will loop back to step 602 and wait for the next polling period.

If in step 606, the flag value is indicative of a change to the Running Configuration, the method continues to step 608 where the NOC 4 obtains the checksum for the new Running Configuration. In step 610, the NOC 4 compares the checksum for the new Running Configuration to the reference checksum corresponding to the Reference Configuration. If the checksum for the new Running Configuration is identical to the reference checksum, the method 600 will loop back to step 602 to wait for the predetermined time interval before rechecking the flag value. Again, this obtaining and comparing of the checksums may eliminate the need to use network bandwidth to obtain the entire Running Configuration file. It should be noted that the NOC 4 may utilize two different Reference Configurations (and reference checksums) for the Saved and Running Configurations, respectively.

If the checksums are different, the method 600 continues to step 612 where the NOC 4 obtains the data file for the new Running Configuration. As with the above described methods 400 and 500, by analyzing the data file, the change to the Running Configuration file may be identified. An operator may then determine whether the change should be accepted or rejected. If the change is accepted, the data file for the new Running Configuration and the checksum thereof may replace the Reference Configuration and the reference checksum. If the change is rejected, an instruction may be transmitted to the switch 14 to revert to the Running Configuration and/or to use the Reference Configuration.

Those skilled in the art will understand that the exemplary embodiments of the present invention allow the NOC 4 to monitor operation of all or selected ones of the computing devices in the system 2 without usurping the network bandwidth. That is, the NOC 4 uses the checksums and counter and flag values to determine whether a change to the computing devices has actually been made, and only then retrieves the full configuration data file.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
storing a first configuration data file;
altering the first configuration data file to create a second configuration data file; and
creating a reference value corresponding to the second configuration data file.

2. The method of claim 1, further comprising:
setting an indicator to a value that indicates the second configuration data file is different from the first configuration data file.

3. The method of claim 2, wherein the indicator is a flag.

4. The method of claim 1, further comprising:
transmitting the reference value.

5. The method of claim 1, wherein the reference value is one of a checksum and a hash value.

6. The method of claim 1, further comprising:
transmitting the second configuration data file.

7. The method of claim 1, further comprising:
receiving a save command to store the second configuration data file; and
storing the second configuration data file.

8. The method of claim 7, further comprising:
generating an indicator signal indicative of the receipt of the save command; and
transmitting the indicator signal.

9. The method of claim 8, wherein the indicator signal is a trap.

10. The method of claim 7, further comprising:
incrementing a counter in response to receiving the save command.

11. The method of claim 10, further comprising:
receiving a request for a value of the counter; and
transmitting the counter value.

12. A device, comprising:
a memory storing a first configuration data file; and
a processor altering the first configuration data file to create a second configuration data file and creating a reference value corresponding to the second configuration data file.

13. The device of claim 12 wherein the processor sets an indicator to a value that indicates the second configuration data file is different from the first configuration data file.

14. The device of claim 12, further comprising:
a transmitter transmitting the reference value.

15. The device of claim 14, wherein transmitter further transmits the second configuration data file.

16. The device of claim 12, wherein the processor receives a save command to store the second configuration data file and stores the second configuration data file in the memory.

17. The device of claim 16, wherein the processor generates an indicator signal indicative of the receipt of the save command and the transmitter transmits the indicator signal.

18. The method of claim 16, wherein the processor increments a counter in response to receiving the save command.

19. A method, comprising:
receiving a first reference value from a computing device, the first reference value corresponding to a first configuration data file utilized by the computing device;
comparing the first reference value to a second reference value corresponding to a second configuration data file; and
upon detecting a difference between the first and second reference values, obtaining the first configuration data file from the computing device.

20. The method according to claim 19, further comprising:
receiving an indicator signal from the computing device, the indicator signal indicating that the computing device is utilizing the first configuration.

21. The method according to claim 20, wherein the indicator signal is trap.

22. The method according to claim 19, wherein the first and second reference values are one of checksums and hash values generated as a function of the first and second configuration data files, respectively.

23. The method according to claim 19, further comprising:
receiving a current counter value from a counter on the computing device, the counter counting configuration changes; and
comparing the current counter value to a previous counter value to determine whether the first configuration data file is a result of one of the configuration change.

24. The method according to claim 19, further comprising:
receiving a flag value from the computing device; and
determining whether the first configuration data file is a result of a configuration change based on the flag value.

25. A device, comprising:
a memory storing a first reference value corresponding to a first configuration data file;
a processor receiving a second reference value from a computing device, the second reference value corresponding to a second configuration data file utilized by the computing device, the processor comparing the first reference value to the second reference value and, upon detecting a difference between the first and second reference values, generating a request for the second configuration data file from the computing device.

26. The device of claim 25, further comprising:
a transmitter transmitting the request to the computing device.

27. The device of claim 25, wherein the processor receives an indicator signal from the computing device, the indicator signal indicating that the computing device is utilizing the second configuration.

28. The device of claim 25, wherein the processor receives a current counter value from a counter on the computing device, the counter counting configuration changes and compares the current counter value to a previous counter value to determine whether the first configuration data file is a result of one of the configuration change.

29. The device of claim 25, wherein the processor receives a flag value from the computing device and determines whether the second configuration data file is a result of a configuration change based on the flag value.

30. A system, comprising:
a first device having a first configuration file, the first device computing a first value based on the first configuration file; and
a second device having a reference configuration file and a reference value based on the reference configurations file, the second device receiving the first value from the first device and comparing the values, wherein, if the values are different, the second device requests the first configuration file from the first device.

31. A device, comprising:
a memory means for storing a first configuration data file; and
a processing means for altering the first configuration data file to create a second configuration data file and creating a reference value corresponding to the second configuration data file.

32. A device, comprising:
a memory means for storing a first reference value corresponding to a first configuration data file;
a processing means for receiving a second reference value from a computing device, the second reference value corresponding to a second configuration data file utilized by the computing device, the processing means comparing the first reference value to the second reference value and, upon detecting a difference between the first and second reference values, generating a request for the second configuration data file from the computing device.
